(19) United States
(12) Patent Application Publication
(10) Pub. No.: US 2009/0214134 A1
(43) Pub. Date: Aug. 27, 2009

(54) SYSTEM AND METHOD FOR IMAGE DATA EXTRACTION AND ASSEMBLY IN DIGITAL CAMERAS

(75) Inventor: George John, Arlington Heights, IL (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 12/038,574

(22) Filed: Feb. 27, 2008

(51) Int. Cl. G06K 9/36

(52) U.S. Cl. 382/284

(57) ABSTRACT

A system and method for data extraction and assembly in digital cameras is provided. The system and method provides the ability to extract symbol data, including textual and other character data from multiple camera images, and assemble the extracted symbol data into a composite document. The system and method can perform this data extraction using limited resources, and thus it can be implemented in digital cameras that have limited memory and processing capacity

### FIELD OF THE INVENTION

This invention generally relates to digital cameras, and more specifically relates to image processing in digital cameras.

### BACKGROUND OF THE INVENTION

Digital imaging systems have created a revolution in photography and cameras. A digital camera is similar to a film camera except that the film is replaced with an electronic sensor. The sensor is comprised of an array of photo detectors that generate an electrical signal proportional to the light incident at each detector. The digital camera processes the data from each detector, and combines the data to form digital image. The digital image can then further processed, transferred or printed as desired.

Modern digital cameras typically include the ability to perform a variety of different types of processing on the image data. One type of processing is typically referred to as image stitching or photo stitching. In image stitching, multiple digital images are combined to produce a larger image, such as a wide angle panorama image. Image stitching typically requires that the camera analyze the images for translation and rotation, and matches adjoining areas of the images for color contrast and brightness to avoid the stitched parts being easily noticeable. Because the camera must store data from multiple images and perform significant processing, image stitching requires significant resources. While these resources may be available on high-end digital cameras, they may not be available on cameras that are necessarily smaller and cheaper.

For example, digital cameras are commonly implemented in mobile communication devices such as phones and personal digital assistants. In many cases to reduce cost and size, these digital cameras are implemented with limited resources, such as limited memory and processing capability. In these types of camera the resources necessary for full image stitching may not be available. However, there remains a need for data capture in these types of camera from multiple images.

### BRIEF DESCRIPTION OF DRAWINGS

The preferred exemplary embodiment of the present invention will hereinafter be described in conjunction with the appended drawings, where like designations denote like elements, and:

FIG. 1 is a schematic view of an digital camera with an image processing system in accordance with an embodiment of the invention; and

FIG. 2 is a flow diagram illustrating a digital processing method in accordance with an embodiment of the invention.

### DETAILED DESCRIPTION OF THE INVENTION

The present invention provides a system and method for data extraction and assembly in digital cameras. The system and method provides the ability to extract symbol data, including textual and other character data from multiple camera images, and assemble the extracted symbol data into a composite document. The system and method can perform this data extraction using limited resources, and thus it can be implemented in digital cameras that have limited memory and processing capacity.

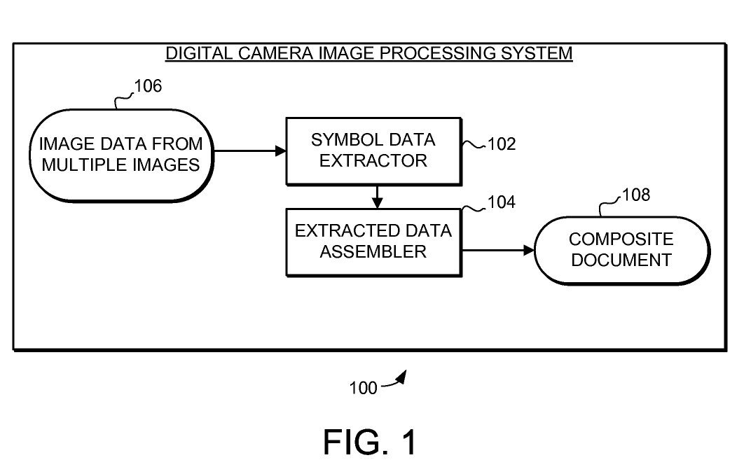

Turning now to FIG. 1, a digital camera image processing system 100 in accordance with the embodiments of the invention is illustrated. The digital camera image processing system 100 includes a symbol data extractor 102 and an extracted data assembler 104. In general, the processing system 100 receives multiple digital images 106 taken by the digital camera, extracts symbol data from the multiple camera images, and assembles the extracted symbol data into a composite document 108. Specifically, the symbol data extractor 102 analyzes the digital images to extract symbol data from the images. The data assembler 104 identifies position markers in the digital images and assembles the extracted symbol data into a composite document based on the identified position markers in the first digital image and the second digital image. Specifically, the data assembler 104 assembles the extracted symbol data from the multiple images in their correct relative positions, as determined from the locations of the identified position markers. Thus, the digital camera image processing system 100 can be used to generate a composite document that includes the extracted symbols from multiple images, arranged in their proper relative positions. Furthermore, this composite document can be created using relatively low processing and memory resources, and thus can be implemented in a wide variety of digital cameras.

As one example application, the digital camera image processing system 100 can be used to capture information contained on a display surface, such as a whiteboard, where multiple overlapping images are taken to cover the display surface. In this application, the digital camera is used to take multiple, overlapping images of the white board. The data extractor 102 analyzes the image data from these multiple images to extract the symbol data. This symbol data can include all the text and other character information contained in the images, and thus can be used to capture the text, characters and other symbols written on the whiteboard.

The data assembler 104 then identifies position markers in the multiple images. These image markers can include any identifiable features found in the overlapping portions of the images. The data assembler can then create a composite document that includes the extracted symbols from the multiple images placed in their correct relative positions. Thus, the composite document can comprise a simplified image document or even a text document, with the characters of the document arranged as they were originally found on display surface. A user of the digital camera can thus easily capture text and other symbol information displayed on a whiteboard, even when that information requires multiple camera images.

Furthermore, because the digital camera image processing system 100 extracts the symbol data from the images, and then assembles only the extracted symbol data into the composite document, the processing and memory requirements for the system are greatly reduced. As discussed above, in traditional image stitching the original camera images are combined to create a larger, panorama image. This traditional image stitching thus requires the camera to store and process the complete image data from multiple images simultaneously, and thus requires significant processing resources. In contrast, the digital camera image processing system 100 extracts the symbol data from the images, and then assembles only the extracted symbol data into the composite document. The digital camera image processing system 100 thus requires significantly less resources and can be implemented on relatively inexpensive cameras.

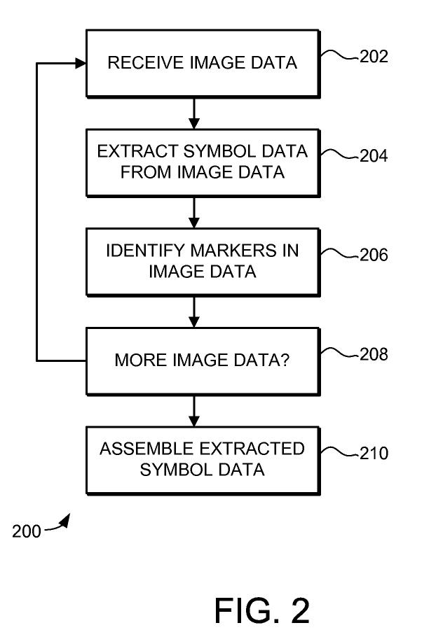

Turning now to FIG. 2, a method 200 for processing digital images in a digital camera is illustrated. In general, the method 200 receives multiple digital images taken by the digital camera, extracts symbol data from the multiple camera images, and assembles the extracted symbol data into a composite document. The method 200 could be performed in a variety of ways. As one example, the method 200 could be implemented such that a user takes a series of pictures of a display surface, and then selects the relevant pictures and manually instigates the data extraction and assembly of the selected pictures. As another example, the method 200 could be implemented to be performed with the taking of each picture when operating in a particular mode. In this implementation, as each picture is taken, the data is extracted and stored for assembly. In any case, the image data from multiple pictures is analyzed, data extracted and assembled into the composite document.

The first step 202 of the method 200 is to receive image data from the digital camera. Typically, the format and resolution of the image data will depend upon the type of digital camera in which the method is implemented. For example, the number of pixels, and the number of bits used to represent each pixel, will depend on the specific implementation of the sensor in the digital camera. Likewise, the image data can comprise a variety of standard formats, such as JPG, BMP or RAW data formats commonly used in digital cameras.

The next step 204 is to extract symbol data from the image. This can be accomplished using a variety of techniques. For example, a relatively simple thresholding operation can be used that renders each pixel black or white, depending on the intensity of the image at that pixel. As one specific example, in an 8 bit representation, the values for each pixel can range from 0 to 255. An extraction that results in a binary representation can be obtained by applying a threshold value above which all pixels will be set to 1, and all other pixels will be set to 0.

In a RAW image, the threshold value can be the same or different for each color pixel in the color filter array. This will yield a binary image with a single channel. In an RGB image, such a threshold can be applied separately across the three color channel to preserve some color information. Likewise, in an YCrCb image such a threshold can be applied based on the luminance (Y) channel alone. Furthermore, to increase the level of color information multiple thresholds can be applied instead of one, resulting in more than two values for each pixel.

The threshold values used can be static, predetermined values, or they can be determined for each image. For example, the threshold can be determined statistically for each image. In one technique, the mean and standard deviation of the pixel values can be computed, and the threshold can then be set as the sum or the mean and the standard deviation. Such a technique would help reduce the extraction of irrelevant information from the image.

Additionally, such a threshold value could be used for all images in the compound document instead of calculating a threshold value for each individual image based on local statistics.

Regardless of the technique used, the result of the data extraction is that symbol data of a certain level of intensity is extracted from the image, while all background information is removed. As such, it can be used to capture the shape, text and other symbols written on a whiteboard.

It should be noted that such an operation will represent the image data in a way that significantly reduces the data size. Specifically, storing the symbols as simple black pixels while rendering all other image locations white would remove all other color and intensity information, and thus dramatically reduce the size of the image data. The extracted data can then be manipulated with relatively low processing requirements.

The next step 206 is to identify position markers in the image data. These image markers can include any identifiable features found in the overlapping portions of the images. Typically, the image markers identified would depend on the type of technique that will be used to assemble extracted symbol data. As one example, a subset of the extracted symbol data can be used as position markers. In this case, the position markers could be identified using a thresholding technique as was described above.

In one specific embodiment, a second threshold could be used to identify image markers. This second threshold could also be a predetermined value, or it could also be determined statistically for each image or for each composite document. Again, this is just one example of how position markers in the image data can be identified.

The next step 208 is to determine if more image data is to be analyzed and added. When more image data is to be analyzed, the method returns to step 202 and performs steps 204 and 206 for the next image. This process is continued until the image data for each of the images has been analyzed and the data extracted.

The method then proceeds to step 210. In step 210, the extracted symbol data from the multiple images is assembled into one composite document. The position markers previously identified are used to determine the correct relative positions of the extracted symbol data. Furthermore, the position markers and symbol data can be used to scale the extracted symbol data such that the symbol data is all assembled at the same size scale.

A variety of different techniques can be used to assemble the extracted symbol data. These techniques would typically depend on the format used to store the composite document. For example, a frame size can be defined, with the locations of symbols and markers in the frame stored along with the corresponding symbol and marker data.

For example, in one technique, the extracted image data and identified markers are examined for overlap by searching for common patterns in the symbols and markers. Once overlapping markers are identified, the frames of data from each image can be aligned and stitched together. This can be accomplished using techniques such as image registration and mosaicing. In general, image registration aligns whole or part of an image on top of another by identifying matching content. Similarly, mosaicing stitches images together like a jigsaw. One example of a mosaicing approach would be to correlate the features near the corner of one frame to the corner of another frame, and use these correlations to align the two frames together. The features can include both symbol and marker data extracted from the original images. Thus, the extracted image data can be assembled by aligning overlapping parts using image registration techniques, and then using this information to create a mosaic of adjacent pieces of extracted data. Alternatively, the mosaic of extracted data can be created using edge and corner information only, without using image registration.

As stated above, one potential application of the data extraction and assembly technique is to capture text and other shapes written on a surface such as a white board. In this application, an image is taken of a portion of the white board. A data extraction process such as thresholding is then used on the image. After such a process, areas of the image with shape or other text will have a value of 1, while other areas will be 0. There may be other features such as smudges or edges of the white board that can serve as markers which will also have the value 1. Using an absolute threshold, such information can be extracted close to the frame boundaries. One could then use a suitable compression algorithm to further reduce the size of the image.

Next, another image is taken that covers another portion of the white board, with some area of overlap. Data extraction is then applied to this image. The resulting extracted data will have features that overlap with the features extracted from the first image. Since the capture device and settings are known for both images, the relative shift between the two documents can be estimated based on the registration of the symbols as well as the markers using well-known algorithms.

The relative shift between the documents provides the ability to assemble the document into one composite document. Thus, the method provides the ability to extract symbol data, including textual and other character data from multiple camera images, and assemble the extracted symbol data into a composite document. The method can perform this data extraction using limited resources, and thus it can be implemented in digital cameras that have limited memory and processing capacity.

While the above techniques have been described in the context of a system and method, they are equally applicable other implementations. For example, they can be implemented as part of a computer implemented method, with any type of processor and memory system, include single integrated circuits such as a microprocessor, or may comprise any suitable number of integrated circuit devices and/or circuit boards working in cooperation to accomplish the functions of a processing unit and memory. It should also be understood that mechanisms of system and method are capable of being distributed as a program product in a variety of forms, and that the present invention applies equally regardless of the particular type of computer-readable signal bearing media used to carry out the distribution. Examples of signal bearing media include: recordable media such as flash memory, floppy disks, hard drives, memory cards and optical disks.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims.

1. A method of processing digital images in a digital camera, the method comprising the steps of:
generating a first digital image and a second digital image with the digital camera;
extracting symbol data from the first digital image and the second digital image;
identifying position markers in the first digital image and the second digital image; and
assembling the extracted symbol data from the first digital image and the second digital image into a composite document based on a correlation of the position markers in the first digital image and the second digital image.

2. The method of claim 1 wherein the step of extracting symbol data from the first digital image and the second digital image comprises capturing pixel data having an intensity above a specified threshold and discarding pixel data having an intensity below the specified threshold.

3. The method of claim 1 wherein the first digital image and the second digital image comprise partially overlapping images of a display surface.

4. The method of claim 3 wherein the display surface comprises a whiteboard, and wherein the extracted symbol data comprises data representing writings on the whiteboard.

5. The method of claim 1 wherein the step of extracting symbol data from the first digital image comprises capturing pixel data having an intensity above a threshold, where the threshold is determined from a statistical analysis intensity in the first digital image.

6. The method of claim 5 wherein the threshold is determined from a sum of a mean and a standard deviation of the intensity of the first digital image.

7. The method of claim 1 wherein the step of assembling the extracted symbol data from the first digital image and the second digital image into the composite document based comprises utilizing an image registration technique.

8. The method of claim 1 wherein the step of assembling the extracted symbol data from the first digital image and the second digital image into the composite document based comprises utilizing a mosaicing technique.

9. A processor, tangibly embodying a program of instructions to perform method steps for digital image processing in a digital camera, comprising the machine executed steps of:
generating a first digital image and a second digital image with the digital camera;
extracting symbol data from the first digital image and the second digital image; identifying position markers in the first digital image and the second digital image; and assembling the extracted symbol data from the first digital image and the second digital image into a composite document based on a correlation of the position markers in the first digital image and the second digital image.

10. The processor of claim 9 wherein the step of extracting symbol data from the first digital image and the second digital image comprises capturing pixel data having an intensity above a specified threshold and discarding pixel data having an intensity below the specified threshold.

11. The processor of claim 9 wherein the first digital image and the second digital image comprise partially overlapping images of a whiteboard, and wherein the extracted symbol data comprises data representing writings on the whiteboard.

12. The processor of claim 9 wherein the step of extracting symbol data from the first digital image comprises capturing pixel data having an intensity above a threshold, where the threshold is determined from a statistical analysis intensity in the first digital image.

13. The processor of claim 12 wherein the threshold is determined from a sum of a mean and a standard deviation of the intensity of the first digital image.

14. The processor of claim 9 wherein the step of assembling the extracted symbol data from the first digital image and the second digital image into the composite document based comprises utilizing an image registration technique.

15. The processor of claim 9 wherein the step of assembling the extracted symbol data from the first digital image and the second digital image into the composite document based comprises utilizing a mosaicing technique.

16. A digital processing system in a digital camera, the digital processing system comprising:
a data extractor, the symbol data extractor configured to receive a first digital image and a second digital image generated by the digital and extract symbol data from the first digital image and the second digital image; and
a data assembler, the data assembler configured to identify position markers in the first digital image and the second digital image, the data assembler further configured to assemble the extracted symbol data from the first digital image and the second digital image into a composite document based on a correlation of the position markers in the first digital image and the second digital image.

17. The system of claim 16 wherein the data extractor is configured to extract symbol data from the first digital image and the second digital image by capturing pixel data having an intensity above a specified threshold.

18. The system of claim 16 wherein the first digital image and the second digital image comprise partially overlapping images of a whiteboard, and wherein the extracted symbol data comprises data representing writings on the whiteboard.

19. The system of claim 16 wherein the data extractor is configured to extract symbol data from the first digital image by capturing pixel data having an intensity above a threshold, where the threshold is determined from a statistical analysis of intensity in the first digital image.

20. The system of claim 16 wherein the data assembler is configured to assemble the extracted symbol data from the first digital image and the second digital image into the composite document by utilizing an image registration and mosaicing technique.
